(19) United States
(12) Patent Application Publication
(10) Pub. No.: US 2025/0209716 A1
(43) Pub. Date: Jun. 26, 2025

(54) Catch Monitoring Device and Catch Monitoring Method Thereof

(71) Applicant: Wistron Corporation, New Taipei City (TW)

(72) Inventors: Ping-Chen Tsai, New Taipei City (TW); Hsien-Ta Wu, New Taipei City (TW)

(73) Assignee: Wistron Corporation, New Taipei City (TW)

(21) Appl. No.: 18/654,006

(22) Filed: May 3, 2024

(30) Foreign Application Priority Data
Dec. 25, 2023 (TW) 112150549

(51) Int. Cl. G06T 15/00; G06T 7/64; G06V 10/46

(52) U.S. Cl. CPC G06T 15/00; G06T 7/64; G06V 10/46; G06T 2207/20044

(57) ABSTRACT

A catch monitoring device and a catch monitoring method thereof for improving the accuracy of catch estimation and reducing costs are disclosed. The catch monitoring device includes a 2D skeleton unit for generating a 2D skeleton according to a 2D image, a 3D skeleton unit for generating a 3D skeleton according to a 3D point cloud image, and a comparison unit coupled to the 2D skeleton unit and the 3D skeleton unit. The comparison unit determines whether to trigger the catch monitoring device to output catch length, catch girth or catch weight according to the 2D skeleton and the 3D skeleton.

### BACKGROUND OF THE INVENTION

### 1. Field of the Invention

This application concerns a catch monitoring device and a catch monitoring method thereof, and more particularly, to a catch monitoring device and a catch monitoring method thereof that improve the accuracy of fishing catch information estimation and reduce costs.

### 2. Description of the Prior Art

To ensure the rights of fishermen and the sustainability of the oceans, the source of catch must be recorded or tracked by on-board observers or electronic monitoring systems (referred to as electronic observers), and certification must be obtained from the Marine Stewardship Council (MSC). However, on-board observers require long-term extensive professional training and must stay on ship(s) for a long time, leading to a high demand and high personnel costs. On the other hand, employing remote observers to view video recordings from electronic monitoring systems also incurs personnel costs. Additionally, the scenes of fishing operations are diverse and lack a fixed pattern; issues such as varying camera angles, obstruction of the view by crew members or objects, and the constant movement of a captured fish hinder the observation of catch information (e.g., fish length). Accordingly, it must rely on the experience of remote observers to carry out the estimation, which results in low accuracy.

### SUMMARY OF THE INVENTION

A catch monitoring device, comprising a two-dimensional (2D) skeleton unit, configured to generate a 2D skeleton according to a 2D image; a three-dimensional (3D) skeleton unit, configured to generate a 3D skeleton according to a 3D point cloud image; and a comparison unit, coupled to the 2D skeleton unit and the 3D skeleton unit, configured to determine whether to trigger the catch monitoring device to output catch length, catch girth, or catch weight according to the 2D skeleton and the 3D skeleton.

A catch monitoring method, for a catch monitoring device, comprising generating a two-dimensional (2D) skeleton according to a 2D image; generating a three-dimensional (3D) skeleton according to a 3D point cloud image; and determining whether to trigger the catch monitoring device to output catch length, catch girth, or catch weight according to the 2D skeleton and the 3D skeleton.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a catch monitoring device according to an embodiment of the present invention.

FIG. 2 is a schematic diagram of an image correction unit 200 according to an embodiment of the present invention.

FIG. 3 is a schematic diagram of recognition units 310a and 310b according to an embodiment of the present invention.

FIG. 4 is a schematic diagram of a 2D skeleton unit 420 according to an embodiment of the present invention.

FIG. 5 is a schematic diagram of a contour image CNT1 according to an embodiment of the present invention.

FIG. 6 is a schematic diagram of a 3D point cloud unit 630 according to an embodiment of the present invention.

FIG. 7 is a schematic diagram of a 3D skeleton unit 740 according to an embodiment of the present invention.

FIG. 8 is a schematic diagram of features extracted by the 3D skeleton unit 740 from the 3D point cloud image PC according to an embodiment of the present invention.

FIG. 9 is a schematic diagram of a 3D-to-2D unit 950 according to an embodiment of the present invention.

FIG. 10 is a schematic diagram of the 2D skeletons X_{C}a, X_{C}b, X_{C}c and the skeleton projections X_{PROJ}a, X_{PROJ}b, X_{PROJ}c according to an embodiment of the present invention.

FIG. 11 is a schematic diagram of a catch girth estimation unit 1170 according to an embodiment of the present invention.

FIG. 12 is a schematic diagram of a catch weight estimation unit 1270 according to an embodiment of the present invention.

### DETAILED DESCRIPTION

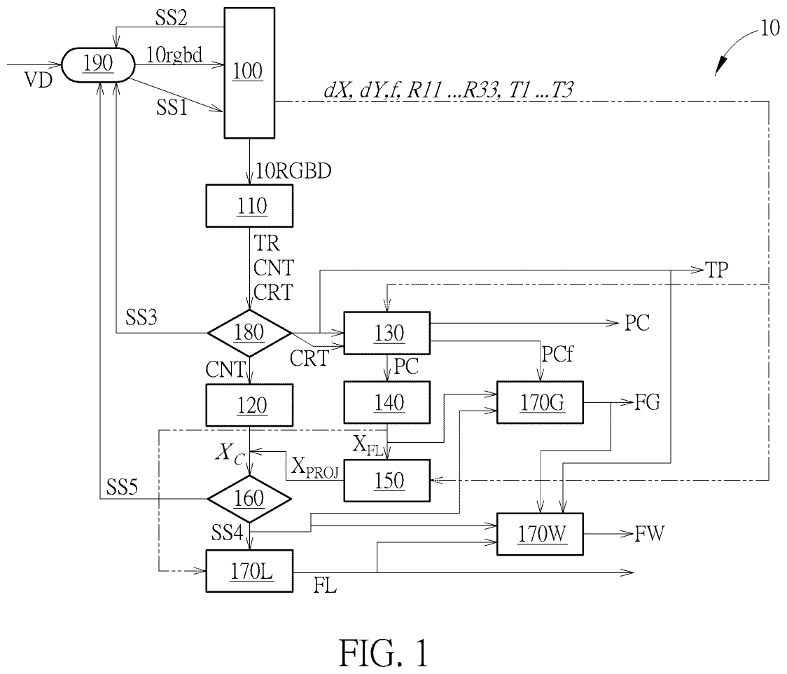

FIG. 1 is a schematic diagram of a catch monitoring device 10 according to an embodiment of the present invention. The catch monitoring device 10 (e.g., for fishing) may comprise an image correction unit 100, a recognition unit 110, a two-dimensional (2D) skeleton unit 120, a three-dimensional (3D) point cloud unit 130, a 3D skeleton unit 140, a comparison unit (which may, for example, comprise a 3D-to-2D unit 150, a curve comparison unit 160), a catch length estimation unit 170L, a catch girth estimation unit 170G, a catch weight estimation unit 170W, a determining unit 180, and a segment processing unit 190.

The image correction unit 100 may convert a distorted image 10rgbd into a (corrected) image 10RGBD. The image 10rgbd (or 10RGBD) may be an RGBD image, and comprise a 2D RGB image with color or grayscale information and a 2D grayscale image with depth information. The image correction unit 100 may instruct the segment processing unit 190 to re-provide another image (e.g., using an instruction signal SS2). The image correction unit 100 may calculate and then output image parameters (e.g., dX, dY, f, R11-R33, T1-T3) to the 3D point cloud unit 130 or the 3D-to-2D unit 150.

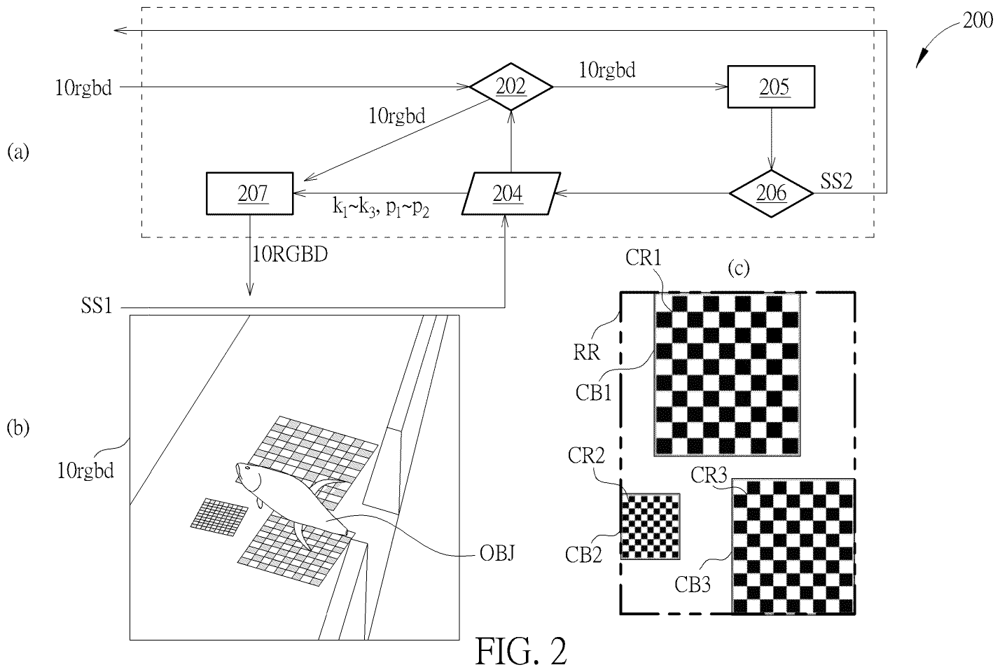

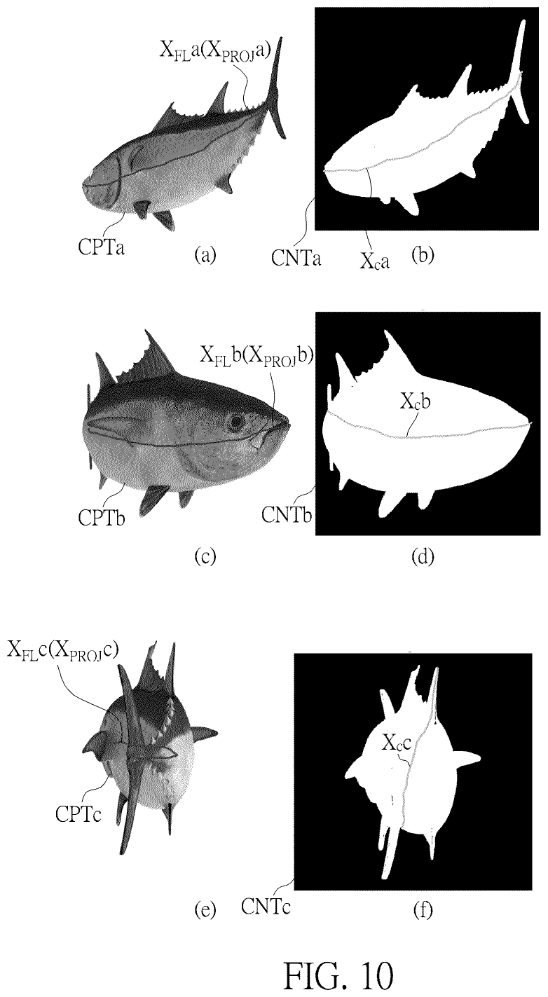

The recognition unit 110 may recognize a species TP (e.g., tuna) of an object (e.g., OBJ shown in FIG. 2) from the image 10RGBD output by the image correction unit 100, and output a contour image CNT (or CNTa, CNTb, CNTc shown in FIG. 10) and an extraction image CPT (or CPTa, CPTb, CPTc shown in FIG. 10) of the object (e.g., OBJ). The contour image (e.g., CNTa) may be, for example, a binary image with two dimensions; the extraction image (e.g., CPTa) may be, for example, an RGBD image.

The 2D skeleton unit 120 may determine a 2D skeleton X_{C} (or X_{C}a, X_{C}b, X_{C}c shown in FIG. 10) of the object (e.g., OBJ), based on the contour image CNT output by the recognition unit 110. The 2D skeleton X_{C} may comprise data points p₁^{C}-p_{NC}^{C} used to depict a curve.

The 3D point cloud unit 130 may output a 3D point cloud image PC and a fin-retracted 3D point cloud image PCf, according to the extraction image CPT and species TP of the object (e.g., OBJ) output by the recognition unit 110. The 3D point cloud unit 130 may add more data points to complete the 3D point cloud image PC. The 3D point cloud image PC or the fin-retracted 3D point cloud PCf may comprise multiple data points used to depict an object (e.g., OBJ).

The 3D skeleton unit 140 may determine a 3D skeleton X_{FL} (or X_{FL}a, X_{FL}b, X_{FL}c) of the object (e.g., OBJ), based on the 3D point cloud image PC complemented by the 3D point cloud unit 130. The 3D skeleton X_{FL} may comprise data points p₁^{FL}-p_{NFL}^{FL} used to depict a curve.

The 3D-to-2D unit 150 may project the 3D skeleton X_{FL} onto a plane, to generate a skeleton projection X_{PROJ} with two dimensions (or X_{PROJ}a, X_{PROJ}b, X_{PROJ}c shown in FIG. 10). The skeleton projection X_{PROJ} of the object (e.g., OBJ) may comprise data points p₁^{PROJ}-p_{NPROJ}^{PROJ} used to depict a curve. The 2D skeleton X_{C} and the skeleton projection X_{PROJ} may be defined with respect to pixel coordinate axes (i.e., the coordinate system of the image 10rgbd or contour image CNT).

The curve comparison unit 160 may compare the 2D skeleton X_{C} with the skeleton projection X_{PROJ}, to determine whether the 2D skeleton X_{C} is similar to the skeleton projection X_{PROJ}. For example, after receiving the 2D skeleton X_{C} and the skeleton projection X_{PROJ}, the curve comparison unit 160 may calculate a score (or distance) for the similarity between the 2D skeleton X_{C} and the skeleton projection X_{PROJ}, based on the Fréchet distance. The curve comparison unit 160 may also compare the score (e.g., 0.58) with a threshold (e.g., 2.5). If the score is less than the threshold, the curve comparison unit 160 determines that the 2D skeleton X_{C} is similar to the skeleton projection X_{PROJ}. Otherwise, the curve comparison unit 160 judges that the 2D skeleton X_{C} is not similar to the skeleton projection X_{PROJ}.

In a word, the 3D skeleton unit 140 extracts the 3D skeleton X_{FL} from the 3D point cloud image PC complemented by the 3D point cloud unit 130. However, an image (e.g., 10RGBD) captured at certain viewing-angles may affect how the 3D point cloud image PC performs data-point-adding to add data points, or how the 3D skeleton unit 140 performs extraction. Therefore, the curve comparison unit 160 uses the 2D skeleton X_{C} extracted by the 2D skeleton unit 120 as an auxiliary reference for judgment, and compares the 2D skeleton X_{C} with the skeleton projection X_{PROJ}, which is formed by projecting the 3D skeleton X_{FL} into the pixel coordinate system, to determine the reliability of the 3D skeleton X_{FL} and whether the 3D skeleton X_{FL} is appropriate for subsequent analysis of catch information. This can ensure the (estimation) accuracy of a catch length FL (e.g., the fork length of a fish), a catch girth FG (e.g., the girth of a fish), a catch weight FW (e.g., the weight of a fish).

For example, FIG. 10 is a schematic diagram of the 2D skeletons X_{C}a, X_{C}b, X_{C}c and the skeleton projections X_{PROJ}a, X_{PROJ}b, X_{PROJ}c according to an embodiment of the present invention. The 2D skeleton X_{C} may be implemented using the 2D skeleton X_{C}a, X_{C}b, or X_{C}c. The skeleton projection X_{PROJ} may be implemented using the skeleton projection X_{PROJ}a, X_{PROJ}b, or X_{PROJ}c. The 3D skeleton X_{FL} may be implemented using the 3D skeleton X_{FL}a, X_{FL}b, or X_{FL}c. As shown in FIG. 10 (a) or (b), when the 3D skeleton X_{FL}a (or X_{FL}b) is projected to form the skeleton projection X_{PROJ}a (or X_{PROJ}b), the skeleton projection X_{PROJ}a (or X_{PROJ}b) is similar to or matches the 2D skeleton X_{C}a (or X_{C}b), which is corresponding to a midline of a 2D contour, so the curve comparison unit 160 may instruct (e.g., using an instruction signal SS4) to estimate the catch length FL, the catch girth FG, the catch weight FW using the 3D skeleton X_{FL}a (or X_{FL}b). As shown in FIG. 10 (c), at a particular viewing angle, when the 3D skeleton X_{FL}c is projected to form the skeleton projection X_{PROJ}c, the skeleton projection X_{PROJ}c does not match the 2D skeleton X_{C}c corresponding to a midline of a 2D contour, so the curve comparison unit 160 may instruct (e.g., using an instruction signal SS5) the segment processing unit 190 to provide another image, to estimate the catch length FL, the catch girth FG, the catch weight FW (without the use of the 3D skeleton X_{FL}c).

According to the trigger or instruction of the curve comparison unit 160 (e.g., indication signal SS4 indicating that a score for the 2D skeleton X_{C} and the skeleton projection X_{PROJ} is below a threshold), the catch length estimation unit 170L may use the 3D skeleton X_{FL} output from the 3D skeleton unit 140, to estimate the catch length FL of the object (e.g., OBJ). For example, the catch length estimation unit 170L may calculate distances, each of which is between any two data points of the 3D skeleton X_{FL}, and then total up all the distances to generate the catch length FL (e.g., FL=Σₘ₌₁^{NFL-1}∥pₘ^{FL}−pₘ₊₁^{FL}∥₂).

The catch girth estimation unit 170G may use the 3D skeleton X_{FL} output by the 3D skeleton unit 140 and the fin-retracted 3D point cloud image PCf output by the 3D point cloud unit 130, to estimate the catch girth FG of the object (e.g., OBJ), according to the trigger or instruction of the curve comparison unit 160.

The catch weight estimation unit 170W may use the catch length FL output by the catch length estimation unit 170L, the catch girth FG output by the catch girth estimation unit 170G, or the species TP output by the recognition unit 110, to estimate the catch weight FW of the object (e.g., OBJ), according to the trigger or instruction of the curve comparison unit 160.

In a word, the catch monitoring device 10 may estimate catch information such as the catch length FL, the catch girth FG, the catch weight FW of the object (e.g., OBJ), which contributes to the statistics of fishery ecology by research institutes or marine associations, or the assessment of catch status in each fishery.

The determining unit 180 may determine whether the species TP of the object (e.g., OBJ) is fish, making the catch monitoring device 10 dedicated to estimating its catch length, catch girth, and catch weight. When the species TP is fish, the determining unit 180 triggers the recognition unit 110 to output (or the determining unit 180 transfers) the species TP, the extraction image CPT, or the contour image CNT to the 2D skeleton unit 120 or the 3D point cloud unit 130. When the species TP is not fish, the determining unit 180 may (e.g., using an instruction signal SS3) instruct the segment processing unit 190 to provide another image, to estimate the catch length FL, the catch girth FG, and the catch weight FW.

In one embodiment, the catch monitoring device 10 may be disposed in a monitor or connected to the monitor or a cloud database. The monitor, which may detect on the surroundings, may provide images (e.g., 10rgbd) or videos with color information (or grayscale information) and depth information.

The segment processing unit 190 may cut a video VD provided by the monitor or the cloud database into multiple images (e.g., 10rgbd). In terms of a video (e.g., VD), the segment processing unit 190 may clear the image parameters (e.g., dX, dY, f, R11-R33, T1-T3, k₁, k₂, k₃, p₁, or p₂) stored in the image correction unit 100 (e.g., using an instruction signal SS1), when the video ends. Since the focal length of scene(s) of the monitor may remain unchanged in terms of a movie (e.g., VD), the segment processing unit 190 may not clear the image parameters stored in the image correction unit 100, allowing images (e.g., 10rgbd) of the same video to undergo image correction or coordinate transformation based on the same image parameters.

FIG. 2 is a schematic diagram of an image correction unit 200 according to an embodiment of the present invention. The image correction unit 100 may be implemented using the image correction unit 200, which may comprise determining modules 202 and 206, a storage module 204, an image parameter extraction module 205, and a correction module 207.

The determining module 202 may determine whether the storage module 204 has stored any image parameters, in response to the trigger of the image 10rgbd output by the segment processing unit 190. If the storage module 204 does not store any image parameters, the determining module 202 instructs the image parameter extraction module 205 to extract image parameter(s) from the image 10rgbd. If the storage module 204 has stored image parameter(s), the determining module 202 instructs the correction module 207 to perform image correction on the image 10rgbd.

The image parameter extraction module 205 may use the image 10rgbd output by the segment processing unit 190 or the determining module 202, to calculate image parameter(s) according to an algorithm. In one embodiment, the image parameter extraction module 205 may calculate image parameter(s) (e.g., dX, dY, f, R11-R33, T1-T3, k₁, k₂, k₃, p₁, or p₂) according to

$$( Formula 1 )$$

$$[ \begin{matrix}{u}^{′} \\ {v}^{′}\end{matrix} ] = ( 1 + {k}_{1} ( {u}^{2} + {v}^{2} ) + {k}_{2} {( {u}^{2} + {v}^{2} )}^{2} + {k}_{3} {( {u}^{2} + {v}^{2} )}^{3} ) [ \begin{matrix}u \\ v\end{matrix} ] + [ \begin{matrix}2 {p}_{1} u v + {p}_{2} ( 3 {u}^{2} + {v}^{2} ) \\ 2 {p}_{1} ( {u}^{2} + 3 {v}^{2} ) + 2 {p}_{2} u v\end{matrix} ]$$

$$( Formula 2 )$$

$$or$$

$$[ \begin{matrix}u \\ v \\ 1\end{matrix} ] = [ \begin{matrix}\frac{1}{dX} & 0 & u 0 \\ 0 & \frac{1}{dY} & v 0 \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}R 11 & R 12 & R 13 & T 1 \\ R 21 & R 22 & R 23 & T 2 \\ R 31 & R 32 & R 33 & T 3 \\ 0 & 0 & 0 & 1\end{matrix} ] [ \begin{matrix}x \\ y \\ z \\ 1\end{matrix} ] ,$$

where the image parameters R11-R33 may constitute a rotation matrix of 3×3, the image parameters T1-T3 may constitute a translation matrix of 3×3, (u′, v′) represents the distorted coordinates of a pixel or a data point of the image 10rgbd with respect to the pixel coordinate axes, (u, v) represents the ideal coordinates of a pixel or a data point with respect to the pixel coordinate axes after image correction, and (x, y, z) represents the world coordinates of a pixel or a data point with respect to world coordinate axes after coordinate transformation.

In one embodiment, the image parameter extraction module 205 on a ship may use Perspective-n-Point (PnP) together with at least one checkerboard (e.g., CB1-CB3) or checkerboard pattern sticker(s) placed on the deck, to calculate the image parameter(s) more accurately. For example, after an object is fished onto the deck from a fish door, the image 10rgbd may capture the object (e.g., OBJ) placed on at least one checkerboard (e.g., CB1-CB3) of the deck. When there is no object (e.g., OBJ) placed on the deck, the image 10rgbd may capture the deck's checkerboard(s) (e.g., CB1-CB3) without being visually unobstructed. If the checkerboards (e.g., CB1-CB3) are unobscured or only partially obscured, the image parameter extraction module 205 may calculate the image parameter(s), based on distorted coordinates (e.g., (u′, v′)) and world coordinates (e.g., (x, y, z)) of the pattern of the checkerboard(s) (e.g., CB1-CB3) in the image 10rgbd. For example, the distorted coordinates of the pixel at the top-left of the image 10rgbd may be (0, 0) with respect to the pixel coordinate axes. The world coordinates of the top left corner (e.g., CR1) of a checkerboard (e.g., CB1) may be (0, 20, 0) with respect to the world coordinate axes. Any two adjacent corners of a checkerboard (e.g., CB1) are consistently separated by a fixed distance (e.g., 20 cm). There is a fixed relative relationship between a corner of one checkerboard (e.g., CB1) and a corner of another checkerboard (e.g., CB2). For example, the relative relationships between top-left corners CR1-CR3 of the checkerboards CB1-CB3 are fixed, and the world coordinates of the top-left corners CR1-CR3 are (0, 20, 0), (120, 0, 0), (120, 62, 0) respectively. Since a checkerboard (e.g., CB1) comprises multiple corners (e.g., 7×7 corners), and multiple checkerboards (e.g., CB1-CB3) may be placed on the deck, the image parameter extraction module 205 may calculate the image parameter(s) (e.g., dX, dY, f, R11-R33, T1-T3, k₁, k₂, k₃, p₁, or p₂) by converting from the distorted coordinates to the world coordinates, with the use of Formula 1 or Formula 2.

The determining module 206 may determine whether the image parameter extraction module 205 has extracted any image parameters. If the image parameter extraction module 205 does not capture any image parameters, the determining module 206 may instruct the segment processing unit 190 to provide another image (e.g., using an instruction signal SS2). If the image parameter extraction module 205 has acquired at least one image parameter, the determining module 206 may store the at least one image parameter in the storage module 204.

The storage module 204 (e.g., a register) may store image parameters (e.g., dX, dY, f, R11-R33, T1-T3, k₁, k₂, k₃, p₁, or p₂). The image parameters dX, dY, f, R11-R33, T1-T3 may be used for coordinate transformation, while the image parameters k₁-k₃, p₁-p₂ may be used for image correction.

In terms of image correction, the correction module 207 may convert the image 10rgbd, which is output by the segment processing unit 190 or the determining module 202, to the image 10RGBD, using the image parameter(s) (e.g., k₁, k₂, k₃, p₁, or p₂) stored in the storage module 204, according to the instruction of the determining module 202. Since at least one lens, optical component, or sensor of the monitor may cause imaging distortion of a video or image (e.g., radial distortion or tangent distortion), the distorted coordinates (u′, v′) of a pixel or data point of the image 10rgbd may be incorrect. However, the correction module 207 may convert the distorted coordinates (u′, v′) to the ideal coordinates (u, v) of the image 10RGBD, for example, through Formula 1, to restore the shape or the coordinates of the object (e.g., OBJ).

In other words, the image correction unit 200 may leverage the pattern of a checkerboard captured by the image 10rgbd to improve the accuracy or efficiency of image correction or coordinate transformation. In one embodiment, the checkerboards on the deck may be of different shapes, and the checkerboards may be parallel or unparalleled to each other. However, the relative relationship of the different checkerboards (e.g., CB1-CB3) on the deck is fixed, and all the checkerboards may define a rectangular area RR. When the object (e.g., OBJ) captured by the image 10rgbd is located within the rectangular area RR, the accuracy of the coordinates for positioning can be improved. In one embodiment, a checkerboard may be implemented using a ChArUco marker image. Since a ChArUco marker image has a known pattern (e.g., QRCode), it facilitates positioning or feature search, and may further improve stability.

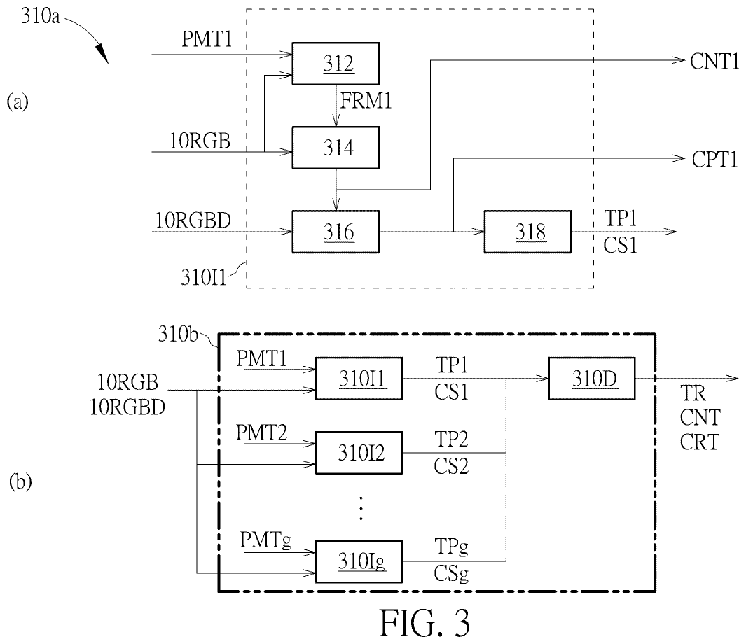

FIG. 3 is a schematic diagram of recognition units 310a and 310b according to an embodiment of the present invention. The recognition unit 110 may be implemented using the recognition unit 310a or 310b.

The recognition unit 310a shown in FIG. 3 (a) may comprise a genus recognition module 310I1, which may comprise an object detection block 312, an object segmentation block 314, an object extraction block 316, and a classifier 318. The object detection block 312, the object segmentation block 314, or the classifier 318 may employ an end-to-end model.

The object detection block 312 may use, for example, Grounding Dino, or other Transformer-based recognition models, and may detect a bounding box FRM1 (e.g., a square bounding box defined by two vertices (x1, y1) and (x2, y2)) corresponding to the object (e.g., OBJ), from the image 10RGB with two dimensions, which is output from the image correction unit 100, according to a prompt PMT1 (e.g., “fish”).

The object segmentation block 314 may use, for example, Segment Anything Model (SAM) or Transformer-based segmentation models, and determine the contour image CNT1 binarized of the object (e.g., OBJ) from the image 10RGB, according to the bounding box FRM1. The length and width of the bounding box FRM1 may be equal to the length and width of the contour image CNT1, respectively.

The object capture block 316 may employ cropping operation(s), and use the contour image CNT1 as a mask. Accordingly, the object capture block 316 may crop the image 10RGBD output by the image correction unit 100, to extract the extraction image CPT1 of the object (e.g., OBJ) from (the position(s) of corresponding pixel(s) or data point(s) of) the image 10RGBD.

The classifier 318 may utilize, for example, a convolutional neural network (CNN) (e.g., VGG, ResNet) or other neural networks, and output the species TP (e.g., bigeye tuna) specifically corresponding to the object (e.g., OBJ) or a confidence score CS1 (e.g., 0.88) corresponding to the species TP, according to the extraction image CPT1. In one embodiment, the classifier 318 needs to be trained for different species (e.g., TP), thus requiring training data with ground truth corresponding to all the possible species (e.g., TP) to be input to the classifier 318 during training. In other words, the object detection block 312 may provide preliminary recognition for genus (e.g., fish) based on the prompt, and the classifier 318 may make further detailed classification for species (e.g., bigeye tuna, bluefin tuna, or yellowfin tuna).

The recognition unit 310b shown in FIG. 3 (b) may comprise genus recognition modules 310I1-310Ig and a determining module 310D. One of the genus recognition modules 310I1-310Ig may be implemented using the recognition unit 310a. Similar to the recognition unit 310a, the genus recognition modules 310I1-310Ig may output species TP1-TPg or confidence scores CS1-CSg for prompt words PMT1-PMTg, according to the image 10RGBD, which is output by the image correction unit 100, and the image 10RGB, which constitutes the image 10RGBD. For example, the genus recognition modules 310I1 outputs the species TP1 (e.g., bigeye tuna) and confidence score CS1 (e.g., 0.88) for the prompt word PMT1 (e.g., fish), according to the images 10RGBD and 10RGB. The genus recognition modules 310I2 outputs the species TP2 (e.g., albatross) and confidence score CS2 (e.g., 0.2) for the prompt word PMT2 (e.g., bird), according to the images 10RGBD and 10RGB. The genus recognition modules 310Ig outputs the species TPg (e.g., green sea turtle) and confidence score CSg (e.g., 0.1) for the prompt word PMTg (e.g., turtle), according to the images 10RGBD and 10RGB.

The determining module 310D may determine which of the confidence levels CS1-CSg is the highest, select the species most likely corresponding to the object (e.g., OBJ), and output the species TP (e.g., TP1) and the contour image CNT (e.g., CNT1), the extraction image CPT (e.g., CPT1) correspondingly.

In other words, the recognition units 310a and 310b, which may adopt pre-trained Transformer as the framework, have the ability to understand visual features (e.g., a bounding box, or a contour image) and the ability to connect text feature(s) (e.g., a prompt) to visual feature(s) (e.g., a bounding box). The recognition units 310a and 310b may identify objects of various genus without retraining, and possess the ability to recognize bycatch across genera (e.g., fish) and determine the exact species (e.g., bigeye tuna) of the object for sub-classification tasks.

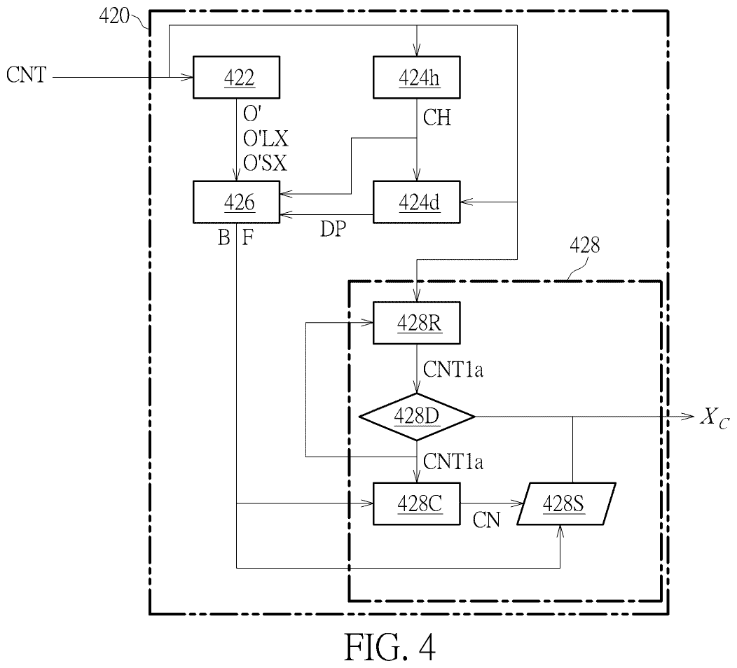

FIG. 4 is a schematic diagram of a 2D skeleton unit 420 according to an embodiment of the present invention. The 2D skeleton unit 120 may be implemented using the 2D skeleton unit 420, which may comprise an analysis module 422, a convex hull point calculation module 424h, a defect point calculation module 424d, and a fish-mouth-point tail-fork-point calculation module 426, and a contour midline calculation module 428. The contour midline calculation module 428 may comprise a computational block 428R, a determining block 428D, a storage block 428S, and a midline point calculation block 428C.

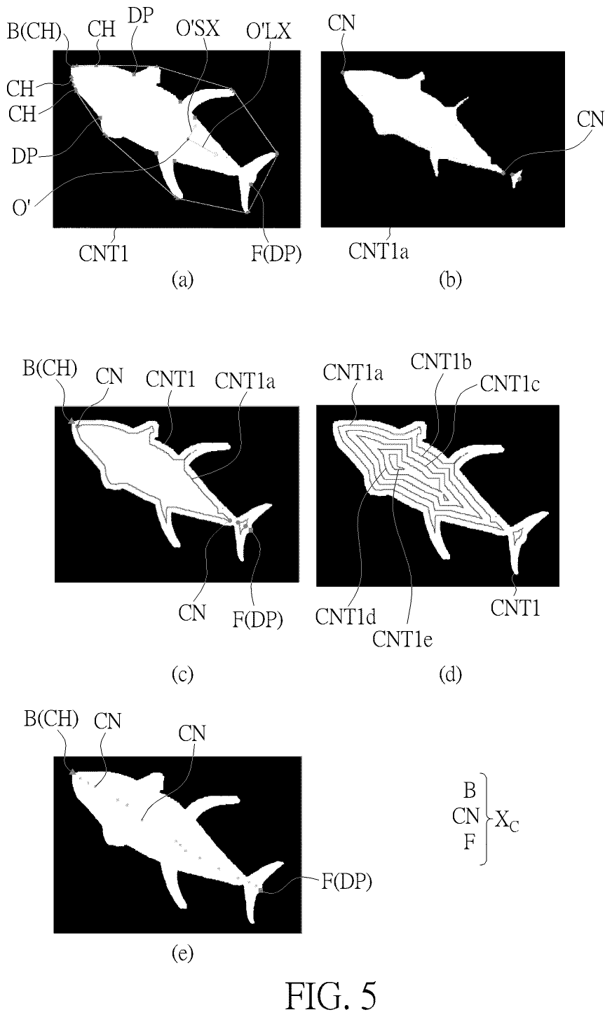

The analysis module 422 may use an algorithm (e.g., principal component analysis (PCA)), to reduce the dimensionality of the contour image CNT output by the recognition unit 110, to obtain a new origin O′, a new major axis O′LX, and a new minor axis O′SX with respect to the pixel coordinate axes. For example, FIG. 5 is a schematic diagram of a contour image CNT1 according to an embodiment of the present invention. The contour image CNT may be implemented using the contour image CNT1. The origin O′, the major axis O′LX, and the minor axis O′SX, which are obtained by reducing the dimensionality of the contour image CNT, are located within the contour of the contour image CNT1 shown in FIG. 5 (a). In other words, the analysis module 422 may perform basis transformation to find the coordinate axes, which match the contour of the contour image CNT, from the contour image CNT with respect to the pixel coordinate axes.

The convex hull point calculation module 424h may calculate convex hull point(s) CH of the contour image CNT output by the recognition unit 110. The convex hull point(s) CH is/are located in protruding part(s) on the contour of the contour image CNT, which may be enclosed entirely by lines (i.e., convex hulls) connecting all the convex hull point(s) CH. A convex hull may be a line joining two adjacent convex hull points CH.

The defect point calculation module 424d may calculate defect point(s) DP of the contour image CNT output by the recognition unit 110. The defect point(s) DP is/are located in concave part(s) on the contour of the contour image CNT. A defect point DP may be the point, which is within a convexity defect and on the contour of the contour image CNT, but is the farthest from the convex hull corresponding to the convexity defect. In other words, the defect point DP on the contour is the farthest from the corresponding convex hull, of all the points on the contour. A convexity defect is the deviation of the contour of the contour image CNT from its convex hull. For example, as shown in FIG. 5 (a), the contour image CNT1 may comprise multiple convex hull points CH and defect points DP.

The fish-mouth-point tail-fork-point calculation module 426 may calculate a fish mouth point B and a tail fork point F, which represent an end of the fish head and a concave end of the fish tail, respectively, according to the origin O′, the major axis O′LX, the minor axis O′SX, the convex hull point(s) CH, or the defect point(s) DP. Since the contour of a fish is long and narrow, the fish mouth point B and the tail fork point F substantially lie on the major axis O′LX of the contour of the contour image CNT but on different sides. Since the fish tail has a concave shape, the tail fork point F may be a defect point DP, which is found along the major axis O′LX and is closest to the major axis O′LX but farthest from the origin O′. For example, the tail fork point F may satisfy θ_{F}<30°,

$${arg max}_{F} \overline{{O}^{′} F} ,$$

and F∈ [symbol] , where [symbol] represents the set of the defect point(s) DP, and θ_{F} represents the angle between O̅′̅F̅ and the major axis O′LX. Since the fish mouth has a convex shape, the fish mouth point B may be a convex hull point CH, which is found along the major axis O′LX and is relatively close to the major axis O′LX but farthest from the origin O′; moreover, the fish mouth point B is located on the other side of the origin O′ relative to the tail fork point F. The fish mouth point B may, for example, satisfy θ_{B}<30°,

$${arg max}_{B} \overline{{O}^{′} B} ,$$

and B∈ [symbol] , where [symbol] represents the set of the convex hull point(s) CH, and θ_{B} represents the angle between O̅′̅B̅ and the major axis O′LX. For example, as shown in FIG. 5 (a), the contour of the contour image CNT1 may comprise the fish mouth point B and the tail fork point F.

The computational block 428R may use an algorithm (e.g., morphological erosion), to calculate another contour image (e.g., the contour image CNT1a shown in FIG. 5 (b)) from one contour image (e.g., the contour image CNT1 shown in FIG. 5 (a)). In other words, the computational block 428R may convert contour images CNT1-CNT1d into contour images CNT1a-CNT1e, respectively. And, the computational block 428R may convert the contour image CNT1e into a background (plain black) contour image (not shown). For example, FIGS. 5 (c) and (d) illustrate the relationship between the contours of the contour images CNT1-CNT1e. Here, the contours of the contour images CNT1-CNT1e are also marked as CNT1 to CNT1e for clarity. The minimum distance between the contour of the contour image CNT1 outputted by the recognition unit 110 and the contour of the contour image CNT1a generated by the computational block 428R is equal to the minimum distance between the contour of the contour image CNT1a and CNT1b generated by the computational block 428R.

The determining block 428D may determine whether the set of boundary point(s) of the contour image (e.g., CNT1a) output by the computational block 428R is an empty set. In FIG. 5, the boundary points form the contour (marked as CNT1-CNT1e in FIGS. 5 (c) and (d) for clarity) of the contour image, where pixels inside the boundary points are white, and pixels outside the boundary points are black. If the determining block 428D determines that the set of the boundary point(s) of the contour image (e.g., a plain-black contour image) is an empty set, the determining block 428D reads or instructs the storage block 428S so that all midline points CN (i.e., the 2D skeleton X_{C}), the fish mouth point B, and the tail fork point F having been already stored in the storage block 428S are output. If the determining block 428D determines that the set of boundary point(s) of the contour image (e.g., CNT1a) is not an empty set, the determining block 428D outputs the contour image (e.g., CNT1a) received from the computational block 428R to the midline point calculation block 428C. In addition, the determining block 428D may output the contour image (e.g., CNT1a) received from the computational block 428R to the computational block 428R, or instruct the computational block 428R to use the latest contour image (e.g., CNT1a) for iterative computation or for an iteration, and thus the computational block 428R may compute another contour image (e.g. CNT1b) corresponding to the contour image (e.g., CNT1a).

The midline point calculation block 428C may determine midline point(s) CN, according to a contour image (e.g., CNT1a) output by the computational block 428R or the determining block 428D, and store the midline point(s) CN in the storage block 428S. For example, after receiving the contour image CNT1a output from the determining block 428D, the midline point calculation block 428C may select boundary point(s) closest to the fish mouth point B and boundary point(s) closest to the tail fork point F, from all the boundary points of the contour image CNT1a, to serve as midline points CN. Since the contour image CNT1a comprises two contours that are separated and unconnected, the contour image CNT1a may comprise two sets of boundary points and four midline points CN, which are respectively corresponding to the two independent boundary-point sets. Similarly, after receiving the contour image CNT1b output by the determining block 428D, the midline point calculation block 428C may select two boundary points closest to the fish mouth point B and the tail fork point F, from all the boundary points of the contour image CNT1b, to serve as two midline points CN, and output the two midline points CN.

The storage block 428S (e.g., a register) may store the fish mouth point B, the tail fork point F, and all the midline point(s) CN, which may constitute the 2D skeleton X_{C}. The 2D skeleton X_{C} may satisfy X_{C}={p₁^{C}, p₂^{C} . . . , p_{NC}^{C}}, where pₘ^{C}=(u, v) represents the ideal coordinates with respect to the pixel coordinate axes, and m represents the index of a data point set and may range from 1 to NC.

In other words, to maintain morphological invariance and find the 2D skeleton X_{C} of the contour image CNT, the contour midline calculation module 428 may select data points, which is closest to the fish mouth point B and tail fork point F of a contour image obtained in each iteration (or iterative computation), to serve as midline points CN, until the contour image (obtained in one certain iteration such as the last iteration) becomes an empty set (e.g., all white pixels in FIG. 5 disappear). Then, the contour midline calculation module 428 may output the 2D skeleton X_{C} comprising the fish mouth point B, the tail fork point F, and all the midline points CN. Although the 2D skeleton X_{C} may not completely match the real biological skeleton, it may represent the structural center of an object or in morphology, or the midline in morphology.

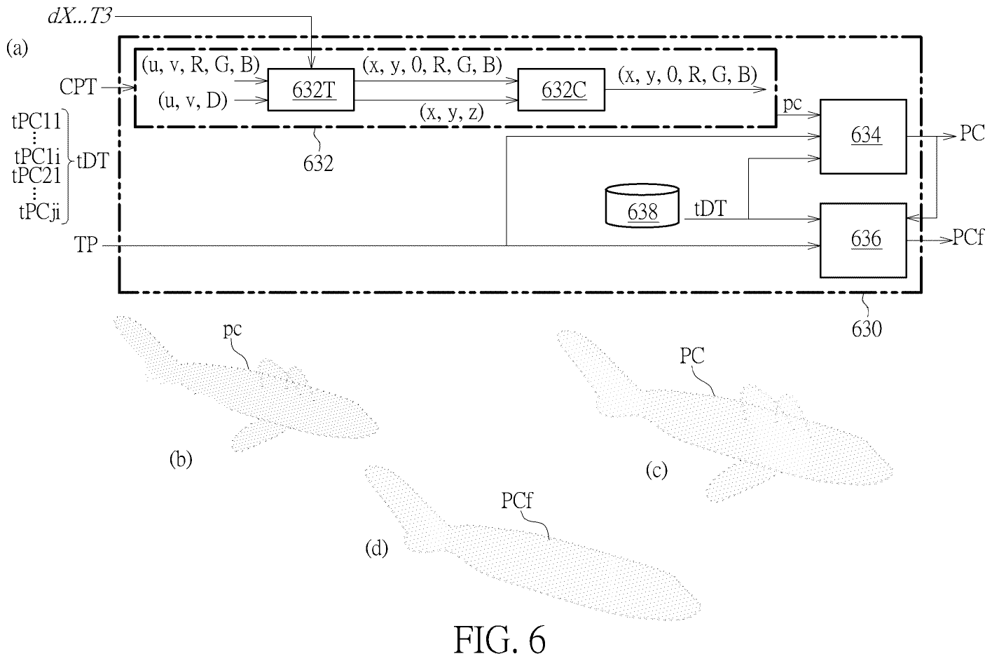

FIG. 6 is a schematic diagram of a 3D point cloud unit 630 according to an embodiment of the present invention. The 3D point cloud unit 130 may be implemented using the 3D point cloud unit 630, which may comprise a transformation module 632, a completion module 634, a matching module 636, and a storage module 638. The transformation module 632 may comprise a coordinate transformation block 632T and a combination block 632C.

The coordinate transformation block 632T may use the image parameter(s) (e.g., dX, dY, f, R11-R33, T1-T3) output by the image correction unit 100, to project the ideal coordinates (e.g., (u, v)) with respect to the pixel coordinate axes and thus convert the ideal coordinates into the world coordinates (e.g., (x, y, z)) with respect to the world coordinate axes, according to, for example, Formula 2 or a pinhole imaging model. Accordingly, the coordinate transformation block 632T may project the pixels of the extraction image CPT (e.g., RGBD image) with respect to the pixel coordinate axes onto a plane with respect to the world coordinate axes. Besides, the coordinate transformation block 632T may output the world coordinates (e.g., (x, y, z)) of the pixels, some of which are corresponding to depth information (e.g., the depth channel value D of a pixel represented by a data point (u, v, D)) with respect to the world coordinate axes, and the data (x, y, 0, R, G, B) of the pixels, which is corresponding to color information (e.g., the color channel value (R, G, B) of a pixel represented by a data point (u, v, R, G, B)).

The combination block 632C may fuse the world coordinates (e.g., (x, y, z)) and data (x, y, 0, R, G, B) to form a data point (x, y, z, R, G, B), and output a 3D point cloud image pc corresponding to the 3D space and color information. In one embodiment, the 3D point cloud image pc may be a partial 3D point cloud image of an object (e.g., OBJ). For example, the 3D point cloud image pc may a part of the object seen from a certain viewing-angle (e.g., the front view), and therefore may comprise only a part of the data points of the complete 3D point cloud image for a part of the object (or a part of the data points of the complete 3D point cloud image from a certain viewing-angle). In one embodiment, the 3D point cloud image pc may be a 3D point cloud image corresponding to an object (e.g., OBJ) but with sparse or uneven data point density.

The completion module 634 can utilize algorithms such as Point Completion Network (PCN) or PMP-Net (point moving path Network), to add other data points (e.g., data points corresponding to the rear-view or the side-view for the 3D point cloud image pc) to the (incomplete) 3D point cloud image pc, based on the 3D point cloud image pc (e.g., corresponding to the front-view) or the species TP of the object (e.g., OBJ). This process results in an output of a complete and high-density 3D point cloud image PC from the completion module 634.

In one embodiment, the model of the completion module 634 may need to be trained in advance to improve stability and accuracy. The completion module 634 may be trained using training data tDT of the species TP during training, so that the 3D point cloud image PC input to the completion module 634 during training or inferencing may match the ground truth (e.g., a 3D point cloud image) provided by the storage module 638. For example, during training, parts of the data points (e.g., a 3D point cloud image corresponding to a part of an object or incomplete data points) of a 3D point cloud image (e.g., tPC11) of the training data tDT may be input to the completion module 634, and the parameters of the completion module 634 may be gradually adjusted (iteration by iteration), until the 3D point cloud image PC generated by the completion module 634 approximates or matches a 3D point cloud image (e.g., tPC11), which is complete and serves as the ground truth. In other words, after providing the training data tDT covering different species (e.g., different fish species), it is possible to train a single or multiple models of the completion module 634 specifically for different species TP. During inferencing, based on the species TP outputted by the recognition unit 110, the appropriate model from the single model or multiple models can be used to complete the 3D point cloud image.

The storage module 638 (e.g., a register) may store the training data tDT, which is labeled data. In one embodiment, the training data tDT may comprise multiple 3D point cloud images tPC11-tPCji generated using a 3D engine rendering platform (e.g., Unity or Blender). In one embodiment, a rigged 3D object model (e.g., a 3D fish model), which is used in the present invention because of its manipulability, may be artificially swung to various angles or strike a pose, to generate 3D point cloud image(s) (e.g., tPC11) of the training data tDT, using the 3D engine rendering platform. Moreover, the 3D fish model may be shoot from different viewing-angles, each of which may show a part of the object (e.g., OBJ) by cutting part of it away with a cross-section plane, to generate incomplete data points, which form a 3D point cloud image (e.g., tPC11) of the training data tDT, to simulate a 3D point cloud images of the object being obscured. Alternatively, incomplete data points of a 3D point cloud image (e.g., tPC11) of the training data tDT, which form an incomplete or sparse 3D point cloud image, may be randomly selected using a program, to simulate a 3D point cloud image, which is interfered by noise or has low resolution. The manner in which the training data tDT is generated for the present invention is not limited thereto.

In one embodiment, the training data tDT of the species TP may comprise multiple groups, each of which may comprise multiple 3D point cloud images tPC11-tPCji of different viewing-angles, different pose angles, and different fin-retraction degrees (e.g., from completely retracted fins to completely extended fins). For example, a first group may comprise multiple 3D point cloud images tPC11-tPC1i of a first viewing-angle, a first pose angle, a first size, and different fin-retraction degrees (e.g., the angle between a fin and the fish body is 0, 15, 30, . . . , or 90 degrees). A second group may comprise multiple 3D point cloud images tPC21-tPC2i of a second viewing-angle, a second pose angle, a second size, and different fin-retraction degrees (e.g., the angle between a fin and the fish body is 0, 15, 30, . . . , or 90 degrees).

The matching module 636 may select a certain group of 3D point cloud image(s) (e.g., tPC11 to tPC1i) from the training data tDT, according to the species TP output by the recognition unit 110. Besides, the matching module 636 may compare the group of the training data tDT with the 3D point cloud image PC having been completed by the completion module 634, and accordingly output the fin-retracted 3D point cloud image PCf corresponding to the 3D point cloud image PC. For example, the matching module 636 may determine the distance between the 3D point cloud image PC and a 3D point cloud image (e.g., tPC13) of a group of the training data tDT, based on, for example, Chamfer Distance. Alternatively, the matching module 636 may determine whether the 3D point cloud image PC matches the 3D point cloud image (e.g., tPC13), based on, for example, Chamfer Distance. When the matching module 636 find a 3D point cloud image (e.g., tPC13) of the training data tDT, which matches the 3D point cloud image PC completed by the completion module 634, the matching module 636 may select the 3D point cloud image (e.g., tPC11) corresponding to the 3D point cloud image (e.g., tPC13) to serve as the fin-retracted 3D point cloud image PCf, which is then output. For example, when the matching module 636 determines that the 3D point cloud image PC matches the 3D point cloud image tPC13 of the first group of the training data tDT, which has the first viewing-angle, the first pose angle, the first size, and the fin-retraction degree of 30 degrees, the matching module 636 may select the 3D point cloud image tPC11 with the first viewing-angle, the first pose angle, the first size, and the fin-retraction degree of 0 degrees, from the first group, to serve as the fin-retracted 3D point cloud image PCf.

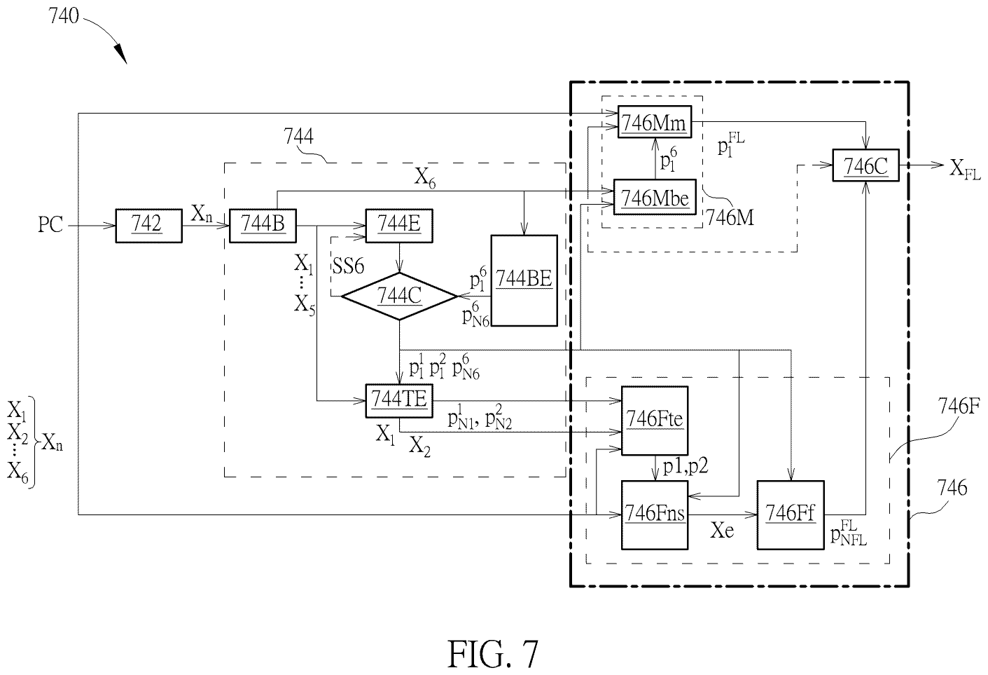

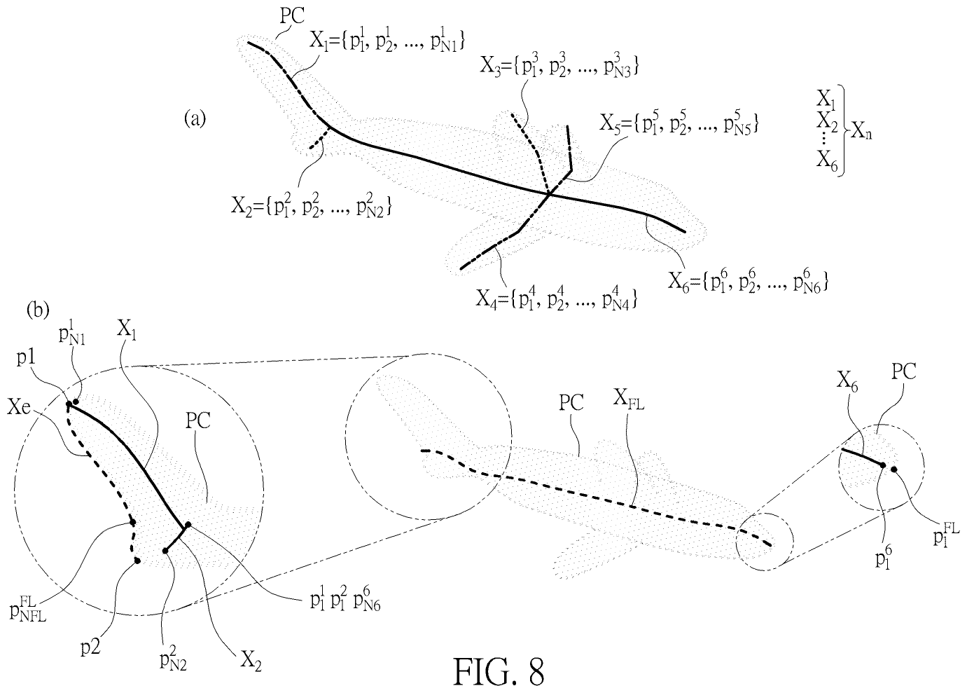

FIG. 7 is a schematic diagram of a 3D skeleton unit 740 according to an embodiment of the present invention. FIG. 8 is a schematic diagram of features extracted, by the 3D skeleton unit 740, from the 3D point cloud image PC according to an embodiment of the present invention. The 3D skeleton unit 140 may be implemented using the 3D skeleton unit 740, which may comprise an overall skeleton extraction module 742, a determining module 744, and a matching module 746. The determining module 744 may comprise a fish body determining block 744B, a fish body skeleton endpoint determining block 744BE, a skeleton endpoint determining block 744E, a comparison block 744C, and a fish tail skeleton endpoint determining block 744TE. The matching module 746 may comprise a fish mouth point determining block 746M, a tail fork point determining block 746F, and a combination block 746C. The fish mouth point determining block 746M may comprise a fish body skeleton endpoint determining sub-block 746Mbe and a fish mouth point calculation sub-block 746Mm. The tail fork point determining block 746F may comprise a fish tail endpoint determining sub-block 746Fte, an intersection determining sub-block 746Fns, and a tail fork point calculation sub-block 746Ff.

In one embodiment, the overall skeleton extraction module 742 may decompose the 3D point cloud image PC complemented by the 3D point cloud unit 130 into components, and slice the components, based on geometric principles. Then, the overall skeleton extraction module 742 may calculate the center of each slice (i.e., a cross-section contour), and combine all the centers of all the slices (of one component) to obtain the component skeleton of the component (referred to as a first component skeleton). The overall skeleton extraction module 742 may then perform optimization processing at the intersection(s) of different components (e.g., adding points in tangent or normal direction(s)) to obtain the overall skeleton. In another embodiment, the overall skeleton extraction module 742 may calculate the overall skeleton based on Laplacian-based contraction. The overall skeleton may comprise multiple second component skeletons connected to each other. Each second component skeleton is a data point set Xₙ (e.g., X₁-X₆) comprising multiple data points, where pₘⁿ=(x, y, z) represents the world coordinates (x, y, z) of a data point pₘⁿ in the 3D point cloud image PC with respect to world coordinate axes, n, which may range from 1 to 6, represents the index of a component, and m represents the index of the data point set Xₙ.

The fish body determining block 744B may calculate the lengths of the data point sets X₁-X₆ according to a length formula, and determine the data point set with the longest length (e.g., X₆={p₁⁶, p₂⁶, . . . , p_{N6}⁶}) to serve as a fish body data point set corresponding to a fish body skeleton. The length formula may, for example, satisfy [symbol] ₙ=Σ_{M=1}^{N-1}∥pₘⁿ−pₘ₊₁ⁿ∥₂, where N represents the number of data points of the n-th component and may be, for example, N1, . . . or N6.

The fish body skeleton endpoint determining block 744BE may determine the two endpoints (e.g., data points p₁⁶, p_{N6}⁶) of the fish body data point set (e.g., X₆={p₁⁶, p₂⁶, . . . , p_{N6}⁶}).

The skeleton endpoint determining block 744E may determine the two endpoints (e.g., data points p₁¹, p_{N1}¹) of a data point set (e.g., X1, . . . or X5) except the fish body data point set (e.g., X₆). Besides, the skeleton endpoint determining block 744E may output the endpoints of different data point sets (e.g., data points p₁¹, p_{N1}¹, data points p₁², p_{N2}², . . . or, data points p₁⁵, p_{N5}⁵) to the comparison block 744C in batches (i.e., set by set).

The comparison block 744C may determine whether the endpoints of the fish body data point set (e.g., p₁⁶, p_{N6}⁶) overlap with or have identical or similar coordinates to the endpoints of other data point sets (e.g., data points p₁¹, p_{N1}¹, data points p₁², p_{N2}², . . . or, data points p₁⁵, p_{N5}⁵), such that the comparison block 744C may output an intersection point p₁¹p₁²p_{N6}⁶. If the endpoints (e.g., p₁³, p_{N3}³) of a data point set fail to overlap with any endpoint of the fish body data point set (e.g., p₁⁶, p_{N6}⁶), the comparison block 744C may instruct the skeleton endpoint determining block 744E to provide endpoints (e.g., p₁⁴, p_{N4}⁴) of another data point set (e.g., using an indication signal SS6). If an endpoint (e.g., p₁¹) of a data point set overlaps with any endpoint of the fish body data point set (e.g., p_{N6}⁶), the comparison block 744C may output the overlapping endpoint (e.g., p₁¹) to serve as the intersection point p₁¹p₁²p_{N6}⁶, because a fish tail skeleton should be connected to the fish body skeleton.

The fish body skeleton endpoint determining block 746Mbe may use the fish body data point set (e.g., X₆={p₁⁶, p₁⁶, . . . , p_{N6}⁶}) output by the fish body determining block 744B and the intersection point p₁¹p₁²p_{N6}⁶ output by the comparison block 744C, to determine an endpoint (e.g., p₁⁶) of the fish body data point set, which is an endpoint near a fish mouth point (e.g., p₁^{FL}) but is not the intersection point p₁¹p₁²p_{N6}⁶. Alternatively, the fish body skeleton endpoint determining block 746Mbe may use the two endpoints (e.g., p₁⁶, p_{N6}⁶) output by the fish body skeleton endpoint determining block 744BE and the intersection point p₁¹p₁²p_{N6}⁶ output by the comparison block 744C, to determine an endpoint (e.g., p₁⁶) of the fish body data point set, which is an endpoint near the fish mouth point (e.g., p₁^{FL}) but is not the intersection point p₁¹p₁²p_{N6}⁶.

The fish mouth point calculation sub-block 746Mm may extend a virtual line from the endpoint (e.g., p₁⁶) adjacent to the fish mouth point (e.g., p₁^{FL}), in the (tangent) direction of the fish body data point set (e.g., X₆={p₁⁶, p₂⁶, . . . , p_{N6}⁶}) corresponding to the fish body skeleton, to the 3D point cloud image PC complemented by the 3D point cloud unit 130, according to the endpoint (e.g., p₁⁶) output by the fish body skeleton endpoint determining block 746Mbe and the fish body data point set (e.g., X₆ {p₁⁶, p₂⁶, . . . , p_{N6}⁶}) output by the fish body determining block 744B. Accordingly, the fish mouth point calculation sub-block 746Mm calculates the intersection of the (tangent) direction and the 3D point cloud image PC to serve as the fish mouth point (e.g., p₁^{FL}).

The fish tail skeleton endpoint determining block 744TE may determine whether the data point set(s) (e.g., X₁-X₅) excluding the fish body data point set (e.g., X₆) comprises the intersection point p₁¹p₁²p_{N6}⁶. The fish tail skeleton endpoint determining block 744TE may determine the data point set(s) (e.g., X₁, X₂) comprising the intersection point p₁¹p₁²p_{N6}⁶, to serve as fish tail data point set(s) corresponding to the fish tail skeleton(s), and output the fish tail data point set(s) (e.g., X₁, X₂). Additionally, the fish tail skeleton endpoint determining block 744TE may determine an endpoint (e.g., p_{N1}¹ or p_{N2}²) of the fish tail data point set (e.g., X₁ or X₂), which is away from the intersection point p₁¹p₁²p_{N6}⁶, and output the endpoint (e.g., p_{N1}¹ or p_{N2}²) of the fish tail data point set to serve as a critical point p_{N1}¹ or p_{N2}².

The fish tail endpoint determining sub-block 746Fte may extend virtual line(s) from the critical point(s) p_{N1}¹, p_{N2}², in the (tangent) direction(s) of the fish tail data point set(s) (e.g., X₁={p₁¹, p₂¹, . . . }, X₂={p₁², p₂², . . . }) corresponding to the fish tail skeleton(s), to the 3D point cloud image PC complemented by the 3D point cloud unit 130, according to the critical point(s) p_{N1}¹, p_{N2}² and the fish tail data point set(s) (e.g., X₁, X₂) output by the fish tail skeleton endpoint determining block 744TE. As a result, the intersection of the (tangent) direction(s) and the 3D point cloud image PC is/are calculated to serve as extended fish tail point(s) (e.g., p1, p2).

The intersection determining sub-block 746Fns may calculate a fan-shaped plane, based on the intersection point p₁¹p₁²p_{N6}⁶ output by the comparison block 744C and the extended fish tail point(s) (e.g., p1, p2) output by the fish tail endpoint determining sub-block 746Fte, and calculate the intersection of the fan-shaped plane and the 3D point cloud image PC complemented by the 3D point cloud unit 130, to serve as an intersection point set (e.g., X_{C}). The intersection point set (e.g., X_{C}), which comprises the extended fish tail point(s) (e.g., p1, p2) serving as its endpoint(s), may roughly demonstrate the shape of the tail fork.

The tail fork point calculation sub-block 746Ff may calculate a data point of the intersection point set (e.g., X_{C}), which is closest to the intersection point p₁¹p₁²p_{N6}⁶ output by the comparison block 744C, to serve as a tail fork point (e.g., p_{NFL}^{FL}), according to the intersection point p₁¹p₁²p_{N6}⁶ and the intersection point set (e.g., X_{C}) output by the intersection determining sub-block 746Fns.

The combination block 746C may combine the fish mouth point (e.g., p₁^{FL}) output by the fish mouth point calculation sub-block 746Mm, the tail fork point (e.g., p_{NFL}^{FL}) output by the tail fork point calculation sub-block 746Ff, and the fish body data point set (e.g., X₆={p₁⁶, p₂⁶, . . . p_{N6}⁶}) output by the fish body determining block 744B, to form a 3D skeleton (e.g., X_{FL}={p₁^{FL}, p₂^{FL}, . . . , p_{NFL}^{FL}}) corresponding to the fork length of a fish.

In other words, the fish body data point set (e.g., X₆={p₁⁶, p₂⁶, . . . , p_{N6}⁶}) corresponding to the fish body skeleton is located in a hollow space enclosed by the 3D point cloud image PC. The 3D skeleton (e.g., X_{FL}={p₁^{FL}, p₂^{FL}, . . . , p_{NFL}^{FL}}) corresponding to the fork length comprises the fish mouth point (e.g., p₁^{FL}), the tail fork point (e.g., p_{NFL}^{FL}), and the fish body data point set (e.g., X₆). Therefore, the 3D skeleton (e.g., X_{FL}) satisfies the requirement for measuring the catch length (e.g., a fork length), which may be measured from the tail fork point to the fish mouth point.

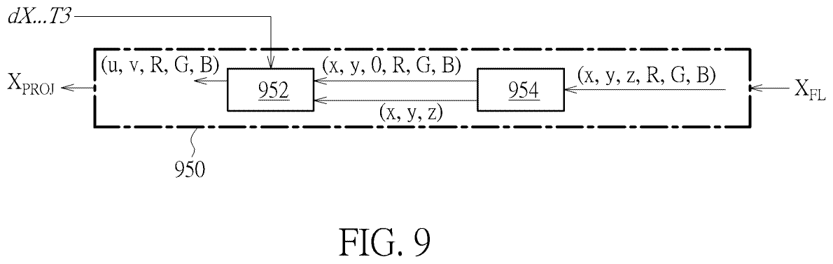

FIG. 9 is a schematic diagram of a 3D-to-2D unit 950 according to an embodiment of the present invention. The 3D-to-2D unit 150 may be implemented using the 3D-to-2D unit 950, which may comprise a coordinate transformation module 952 and a separation module 954.

The separation module 954 may split the data point (x, y, z, R, G, B) of the 3D skeleton X_{FL} into the world coordinates (x, y, z) corresponding to the 3D space and the data (x, y, 0, R, G, B) corresponding to color information.

The coordinate transformation module 952 may use the image parameter(s) (e.g., dX, dY, f, R11-R33, T1-T3) output by the image correction unit 100, to project the world coordinates (e.g., (x, y, z) or (x, y, 0)) with respect to the world coordinate axes and thus convert the world coordinates into the ideal coordinates (e.g., (u, v)) with respect to the pixel coordinate axes, and convert the data (x, y, 0, R, G, B) into a data point (u, v, R, G, B), according to, for example, Formula 2 or a pinhole imaging model. As a result, the coordinate transformation module 952 may output the skeleton projection X_{PROJ} with two dimensions. Each of the data points p₁^{PROJ}−p_{NPROJ}^{PROJ} of the skeleton projection X_{PROJ} may provide the color channel value (R, G, B) of the ideal coordinates (u, v) of a pixel. The skeleton projection X_{PROJ} may be an RGB image.

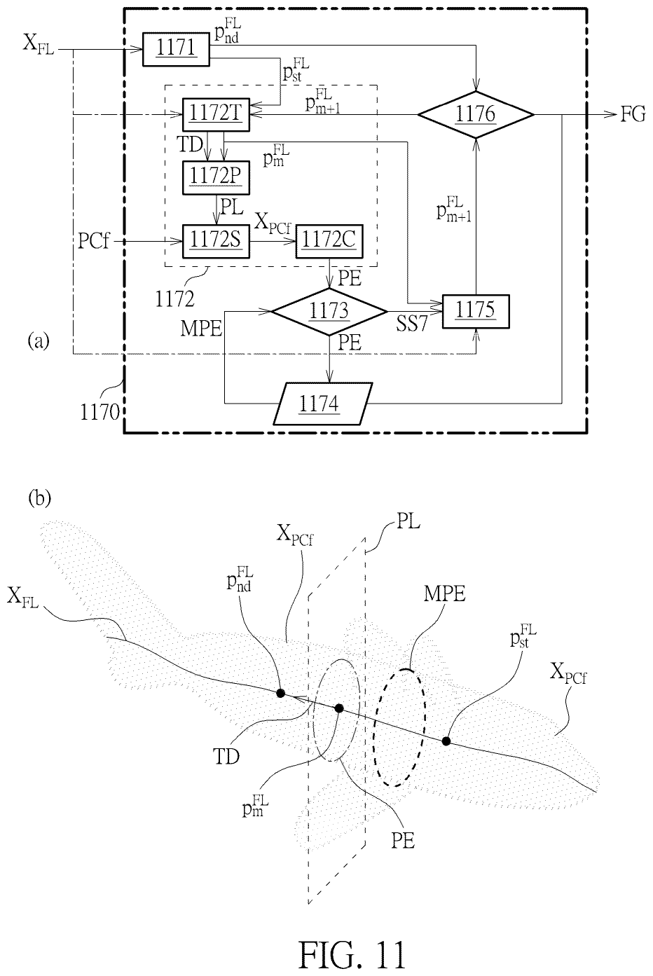

FIG. 11 is a schematic diagram of a catch girth estimation unit 1170 according to an embodiment of the present invention. The catch girth estimation unit 170G may be implemented using the catch girth estimation unit 1170, which may comprise a starting-point-end-point module 1171, a perimeter calculation module 1172, determining modules 1173, 1176, a storage module 1174 (e.g., a register), and a skeleton point generation module 1175. The perimeter calculation module 1172 may comprise a tangent calculation block 1172T, a plane calculation block 1172P, an intersection calculation block 1172S, and a perimeter block 1172C.

The starting-point-end-point module 1171 may select a starting point pₛₜ^{FL} and an end point p_{nd}^{FL}, according to the 3D skeleton (e.g., X_{FL}={p₁^{FL}, p₂^{FL}, . . . , p_{NFL}^{FL}}) output by the 3D skeleton unit 140. The catch girth is the maximum perimeter of all cross sections of the outer surface of the fish body with respect to the 3D skeleton (e.g., X_{FL}), which serves as an axis, and the maximum perimeter is usually close to the center of the fish body. Therefore, the starting point pₛₜ^{FL} and the end point p_{nd}^{FL} may be located at one-thirds and two-thirds of the 3D skeleton (e.g., X_{FL}), respectively.

The tangent calculation block 1172T may calculate a tangent direction TD of the 3D skeleton (e.g., X_{FL}={p₁^{FL}, p₂^{FL}, . . . , p_{NFL}^{FL}}), which is output by the 3D skeleton unit 140, at a skeleton point (e.g., pₘ^{FL}) (also referred to as a point of tangency). When the catch girth estimation unit 1170 is just activated, the skeleton point pₘ^{FL} may be, for example, the starting point pₛₜ^{FL} output by the starting-point-end-point module 1171. During an iteration or iterative computation, the skeleton point pₘ^{FL} may be, for example, a skeleton point, which is generated by the skeleton point generation module 1175 from the previous iteration and is provided from the determining module 1176 to the tangent calculation block 1172T.

The plane calculation block 1172P may determine a plane PL based on the skeletal point (e.g., pₘ^{FL}) and the tangent direction TD outputted by the tangent calculation module 1172T, with the skeletal point (e.g., pₘ^{FL}) being used as the origin and the tangent direction TD being used to define the plane at the skeletal point (e.g., pₘ^{FL}).

The intersection calculation block 1172S may calculate a data point set (e.g., X_{PCf}), each data point of which is the intersection of the plane PL output by the plane calculation block 1172P and the fin-retracted 3D point cloud image PCf output by the 3D point cloud unit 130, according to the plane PL and the fin-retracted 3D point cloud image PCf. The data point set (e.g., X_{PCf}) comprises multiple data points forming a closed or encircling shape (e.g., an ellipse, an egg shape, or an oval-like shape).

The perimeter block 1172C may calculate the perimeter PE corresponding to the skeleton point (e.g., pₘ^{FL}) output by the tangent calculation block 1172T, according to the data point set (e.g., X_{PCf}) output by the intersection calculation block 1172S; for example, the perimeter block 1172C may calculate the distance between any two adjacent data points in the data point set (e.g., X_{PCf}) and then total up all the distances to find the perimeter PE.

The determining module 1173 may determine whether the perimeter PE output by the perimeter block 1172C is greater than the maximum perimeter MPE stored in the storage module 1174. If the perimeter PE is greater than the maximum perimeter MPE, the determining module 1173 stores the perimeter PE into the storage module 1174, to replace the maximum perimeter MPE stored in the storage module 1174. If the perimeter PE is less than or equal to the maximum perimeter MPE, the determining module 1173 (e.g., using an instruction signal SS7) instructs the skeleton point generation module 1175 to generate the next skeleton point (e.g., pₘ₊₁^{FL}).

In response to the instruction of the determining module 1173, the skeleton point generation module 1175 may determine the next skeleton point (e.g., pₘ₊₁^{FL}), which comes after the skeleton point (e.g., pₘ^{FL}) output by the tangent calculation block 1172T, along the 3D skeleton (e.g., X_{FL}), according to the 3D skeleton (e.g., X_{FL}) output by the 3D skeleton unit 140.

The determining module 1176 may determine whether the skeleton point (e.g., pₘ₊₁^{FL}) output by the skeleton point generation module 1175 is the end point p_{nd}^{FL} output by the starting-point-end-point module 1171. If the skeleton point (e.g., pₘ₊₁^{FL}) is not the end point p_{nd}^{FL}, the determining module 1176 outputs the skeleton point (e.g., pₘ₊₁^{FL}), which is provided by the skeleton point generation module 1175 from this iteration, to the tangent calculation block 1172T, to serve as the skeleton point (e.g., pₘ₊₁^{FL}) of the tangent calculation block 1172T for the next iteration. If the skeleton point (e.g., pₘ₊₁^{FL}) is the end point p_{nd}^{FL}, the determining module 1176 reads or instructs the storage module 1174, so that the maximum perimeter MPE having been stored in the storage module 1174 is output to serve as the catch girth FG.

In other words, the catch girth estimation unit 1170 calculates perimeters, for example, from the perimeter corresponding to the starting point pₛₜ^{FL} to the perimeter corresponding to the end point p_{nd}^{FL}. Besides, the catch girth estimation unit 1170 outputs the maximum perimeter (e.g., MPE) of all the perimeters to serve as the catch girth FG. Since the catch girth estimation unit 1170 relies on the fin-retracted 3D point cloud image PCf, which has been complemented and derived by the 3D point cloud unit 130, the catch girth FG estimated by the catch girth estimation unit 1170 is more accurate.

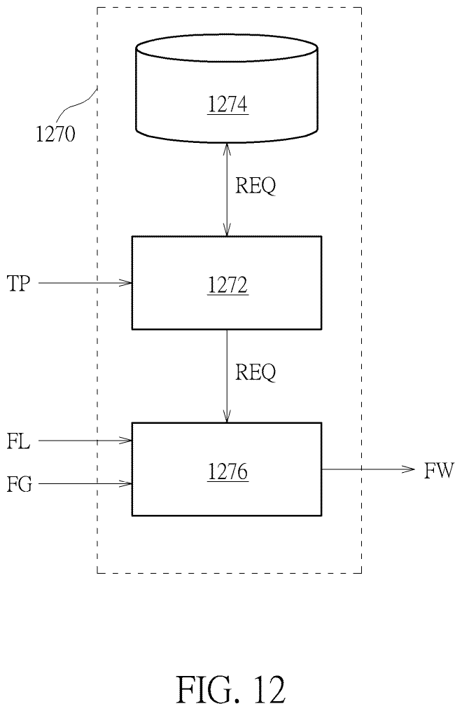

FIG. 12 is a schematic diagram of a catch weight estimation unit 1270 according to an embodiment of the present invention. The catch weight estimation unit 170W is implemented using the catch weight estimation unit 1270, which may comprise a selection module 1272, a storage module 1274 (e.g., a register), and a weight calculation module 1276.

The selection module 1272 may read or select an appropriate relationship equation REQ from the storage module 1274, according to the species TP output by the recognition unit 110. The relationship equation REQ may provide a function of the catch length FL, the catch girth FG, or the catch weight FW. The function or parameter(s) of the function may vary with species (e.g., TP), longitudes, or latitudes. For example, the function for bigeye tuna in the east Atlantic Ocean may satisfy FW=a×FL^{b}. Alternatively, the function for a freshwater fish or a saltwater fish caught by fly fishing or game fishing may satisfy FW=FL×FG²/c (i.e., the catch weight FW is a function of the square of the catch girth FG or a function of the catch length FL), where the catch length FL, the catch girth FG, and the catch weight FW are measured in centimeters and kilograms, and a, b, c represent parameters respectively. The selection module 1272 may select 2.396×10⁻⁵×FL^{2.9774} or FW=FL×FG²/800 as the relationship equation REQ.

The weight calculation module 1276 may use the catch length FL or the catch girth FG to estimate the catch weight FW, according to the relationship equation REQ output by the selection module 1272.

In one embodiment, the object may be, for example, a fish with a hypocercal, heterocercal, or homocercal tail. The catch monitoring device 10 may be applied in scenarios such as trolling or longline fishing.

In one embodiment, each unit (e.g., 100), module (e.g., 202), block (e.g., 428D), or sub-block (e.g., 746Fns) of the catch monitoring device 10 may be implemented using software, firmware, hardware (e.g., circuitry)), or combination thereof. One or some unit(s), module(s), block(s), or sub-block(s) may be omitted according to different requirements. Besides, g, i, j, NC, NFL, N1, . . . , N6, or m are positive integers.

In summary, the present invention utilizes checkerboard(s) and monitor(s) capable of providing depth information, and employs generative artificial intelligence (AI), to replace on-board observer(s) with a catch monitoring device, thereby reducing costs and improving efficiency. Additionally, the present invention performs data fusion of 2D and 3D data and adopts 3D generation techniques, to enhance the accuracy of fishing catch information estimation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A catch monitoring device, comprising:
a two-dimensional (2D) skeleton unit, configured to generate a 2D skeleton according to a 2D image;
a three-dimensional (3D) skeleton unit, configured to generate a 3D skeleton according to a 3D point cloud image; and
a comparison unit, coupled to the 2D skeleton unit and the 3D skeleton unit, configured to determine whether to trigger the catch monitoring device to output catch length, catch girth, or catch weight according to the 2D skeleton and the 3D skeleton.

2. The catch monitoring device of claim 1, further comprising:
an image correction unit, coupled to the 2D skeleton unit and the 3D skeleton unit, configured to convert an image received by the catch monitoring device into a corrected image.

3. The catch monitoring device of claim 1, further comprising:
an recognition unit, coupled to the 2D skeleton unit and the 3D skeleton unit, configured to recognize a species of an object in a corrected image, an extraction image corresponding to the object, and the 2D image, wherein the 2D image is a contour image corresponding to the object.

4. The catch monitoring device of claim 1, further comprising:
a 3D point cloud unit, coupled to the 3D skeleton unit, configured to generate the 3D point cloud image or a fin-retracted 3D point cloud image according to a species of an object and an extraction image corresponding to the object.

5. The catch monitoring device of claim 1, wherein a model of a 3D point cloud unit of the catch monitoring device is trained using a training data group, wherein the training data group comprises a plurality of point cloud images, which are created by rendering a rigged 3D object model using a 3D engine rendering platform, wherein the plurality of point cloud images comprise an object or a part of the object of different viewing-angles, different swing angles, different sizes, different fin-retraction degrees, or different data point densities, respectively.

6. The catch monitoring device of claim 1, wherein a 3D point cloud unit of the catch monitoring device is coupled to the 3D skeleton unit and comprises:
a matching module, configured to select a fin-retracted 3D point cloud image corresponding to the 3D point cloud image from a training data group based on a chamfer distance algorithm, wherein the 3D point cloud image and the fin-retracted 3D point cloud image comprise an object or a part of the object of a same viewing-angle, a same swing angle, a same size, and different fin-retraction degrees, respectively.

7. The catch monitoring device of claim 1, wherein the comparison unit comprises:
a 3D-to-2D unit, coupled to the 3D skeleton unit, configured to project the 3D skeleton into a coordinate system of the 2D image to form a skeleton projection; and
a curve comparison unit, coupled to the 2D skeleton unit and the 3D-to-2D unit, configured to calculate a distance between the 2D skeleton and the skeleton projection according to a Fréchet distance algorithm, and determine whether to trigger the catch monitoring device to output the catch length, the catch girth, or the catch weight according to whether the distance is less than a threshold.

8. The catch monitoring device of claim 1, wherein the 2D skeleton unit comprises:
a computational block, configured to compute at least one 2D image based on the 2D image, wherein a minimum distance between a contour of the 2D image and at least one contour of the at least one 2D image is equal to at least one minimum distance between the at least one contour of the at least one 2D image, and the 2D image is a contour image corresponding to the object; and
a midline point calculation block, coupled to the computational block, configured to select a plurality of midline points, which are closest to a fish mouth point or a tail fork point, from the at least one contour of the at least one 2D image, wherein the 2D skeleton comprises the fish mouth point, the tail fork point, and the plurality of midline points.

9. The catch monitoring device of claim 1, wherein the 2D skeleton unit comprises:
an analysis module, configured to reduce dimensionality of the 2D image to an origin and a major axis, wherein the 2D image is a contour image corresponding to the object;
a convex hull point calculation module, configured to calculate at least one convex hull point of the 2D image, wherein at least one line between the at least one convex hull point encloses a contour of the 2D image, and the at least one convex hull point lies on the contour;
a defect point calculation module, configured to calculate at least one defect point of the 2D image, wherein the at least one defect point on the contour is farthest from the at least one line; and
a fish-mouth-point tail-fork-point calculation module, coupled to the analysis module, the convex hull point calculation module, and the defect point calculation module, wherein the fish-mouth-point tail-fork-point calculation module is configured to select a tail fork point, which is farthest from the origin along the major axis, from the at least one defect point, and select a fish mouth point, which is farthest from the origin and the tail fork point along the major axis, from the at least one convex hull point.

10. The catch monitoring device of claim 1, wherein the 3D skeleton unit comprises:
an overall skeleton extraction module, configured to decompose the 3D point cloud image into a plurality of components, calculate a center of each slice of each of the plurality of components to extract a plurality of first component skeletons of the plurality of components, and calculate a plurality of second component skeletons connected to each other according to the plurality of first component skeletons;
a fish body determining block, coupled to the overall skeleton extraction module, configured to select a fish body skeleton with a longest length from the plurality of second component skeletons;
a comparison block, coupled to the fish body determining block, configured to define an endpoint of the fish body skeleton as an intersection point, wherein the endpoint of the fish body skeleton overlaps at least one of the plurality of second component skeletons except the fish body skeleton of the plurality of second component skeletons;
a fish mouth point determining block, coupled to the fish body determining block and the comparison block, configured to calculate a fish mouth point according to the intersection point, the fish body skeleton, and the 3D point cloud image;
a fish tail skeleton endpoint determining block, coupled to the comparison block, configured to select at least one fish tail skeleton from the plurality of second component skeletons according to the intersection point, and define at least one endpoint of the at least one fish tail skeleton, which is different from the intersection point, as at least one critical point; and
a tail fork point determining block, coupled to the fish tail skeleton endpoint determining block and the comparison block, configured to calculate at least one extended fish tail point according to the at least one fish tail skeleton, the at least one critical point, and the 3D point cloud image, calculate a plane according to the at least one extended fish tail point and the intersection point, calculate an intersection point set according to the plane and the 3D point cloud image, and select a tail fork point, which is closest to the intersection point, from the intersection point set, wherein the 3D skeleton comprises the fish mouth point, the tail fork point, and the fish body skeleton.

11. A catch monitoring method, for a catch monitoring device, comprising:
generating a two-dimensional (2D) skeleton according to a 2D image;
generating a three-dimensional (3D) skeleton according to a 3D point cloud image; and
determining whether to trigger the catch monitoring device to output catch length, catch girth, or catch weight according to the 2D skeleton and the 3D skeleton.

12. The catch monitoring method of claim 11, further comprising:
converting an image received by the catch monitoring device into a corrected image.

13. The catch monitoring method of claim 11, further comprising:
recognizing a species of an object in a corrected image, an extraction image corresponding to the object, and the 2D image, wherein the 2D image is a contour image corresponding to the object.

14. The catch monitoring method of claim 11, further comprising:
generating the 3D point cloud image or a fin-retracted 3D point cloud image according to a species of an object and an extraction image corresponding to the object.

15. The catch monitoring method of claim 11, further comprising:
training a model using a training data group, wherein the training data group comprises a plurality of point cloud images, which are created by rendering a rigged 3D object model using a 3D engine rendering platform, wherein the plurality of point cloud images comprise an object or a part of the object of different viewing-angles, different swing angles, different sizes, different fin-retraction degrees, or different data point densities, respectively.

16. The catch monitoring method of claim 11, further comprising:
selecting a fin-retracted 3D point cloud image corresponding to the 3D point cloud image from a training data group based on a chamfer distance algorithm, wherein the 3D point cloud image and the fin-retracted 3D point cloud image comprise an object or a part of the object of a same viewing-angle, a same swing angle, a same size, and different fin-retraction degrees, respectively.

17. The catch monitoring method of claim 11, wherein determining whether to trigger the catch monitoring device to output the catch length, the catch girth, or the catch weight according to the 2D skeleton and the 3D skeleton comprises:
projecting the 3D skeleton into a coordinate system of the 2D image to form a skeleton projection; and
calculating a distance between the 2D skeleton and the skeleton projection according to a Fréchet distance algorithm, and determine whether to trigger the catch monitoring device to output the catch length, the catch girth, or the catch weight according to whether the distance is less than a threshold.

18. The catch monitoring method of claim 11, wherein generating the 2D skeleton according to the 2D image comprises:
computing at least one 2D image based on the 2D image, wherein a minimum distance between a contour of the 2D image and at least one contour of the at least one 2D image is equal to at least one minimum distance between the at least one contour of the at least one 2D image, and the 2D image is a contour image corresponding to the object; and
selecting a plurality of midline points, which are closest to a fish mouth point or a tail fork point, from the at least one contour of the at least one 2D image, wherein the 2D skeleton comprises the fish mouth point, the tail fork point, and the plurality of midline points.

19. The catch monitoring method of claim 11, wherein generating the 2D skeleton according to the 2D image comprises:
reducing dimensionality of the 2D image to an origin and a major axis, wherein the 2D image is a contour image corresponding to the object;
calculating at least one convex hull point of the 2D image, wherein at least one line between the at least one convex hull point encloses a contour of the 2D image, and the at least one convex hull point lies on the contour;
calculating at least one defect point of the 2D image, wherein the at least one defect point on the contour is farthest from the at least one line; and
selecting a tail fork point, which is farthest from the origin along the major axis, from the at least one defect point, and selecting a fish mouth point, which is farthest from the origin and the tail fork point along the major axis, from the at least one convex hull point.

20. The catch monitoring method of claim 11, wherein generating the 3D skeleton according to the 3D point cloud image comprises:
decomposing the 3D point cloud image into a plurality of components, calculate a center of each slice of each of the plurality of components to extract a plurality of first component skeletons of the plurality of components, and calculate a plurality of second component skeletons connected to each other according to the plurality of first component skeletons;
selecting a fish body skeleton with a longest length from the plurality of second component skeletons;
defining an endpoint of the fish body skeleton as an intersection point, wherein the endpoint of the fish body skeleton overlaps at least one of the plurality of second component skeletons except the fish body skeleton of the plurality of second component skeletons;
calculating a fish mouth point according to the intersection point, the fish body skeleton, and the 3D point cloud image;
selecting at least one fish tail skeleton from the plurality of second component skeletons according to the intersection point, and define at least one endpoint of the at least one fish tail skeleton, which is different from the intersection point, as at least one critical point; and
calculating at least one extended fish tail point according to the at least one fish tail skeleton, the at least one critical point, and the 3D point cloud image, calculate a plane according to the at least one extended fish tail point and the intersection point, calculate an intersection point set according to the plane and the 3D point cloud image, and select a tail fork point, which is closest to the intersection point, from the intersection point set, wherein the 3D skeleton comprises the fish mouth point, the tail fork point, and the fish body skeleton.
